(19) United States
(12) Patent Application Publication
(10) Pub. No.: US 2001/0036764 A1
(43) Pub. Date: Nov. 1, 2001

(54) Stationary device for a mobile device and an electrical connector for the stationary device

(76) Inventor: Akira Funatsu, Tokyo (JP)

Correspondence Address: KANESAKA & TAKEUCHI, 1423 Powhatan Street, Alexandria, VA, 22314, US

(21) Appl. No.: 09/841,107

(22) Filed: Apr. 25, 2001

(30) Foreign Application Priority Data
Apr. 28, 2000 (JP) 2000-129347

(51) Int. Cl. H01R 4/50

(52) U.S. Cl. 439/341

(57) ABSTRACT

A plurality of terminals (15, 16) have contact sections (15A, 16A) projecting from the terminal support (19) of a connector housing (14) to abut against the terminal (34) of a mobile device (30). A pair of mount guiding columns (17) are provided on the connector housing (14) on opposite sides of the terminal support (19) so as to enter the mount recesses 38 of the mobile device (30). The mount guiding column (17) has such a shape and size as to allow the mobile device to rotate to an inclined position with the terminals (15, 16, 34) being in contact. A rotation guiding face (21A) is provided on the connector housing (14) for guiding the mobile device (30) to the inclined position.

### BACKGROUND OF THE INVENTION

1. Field of the Invention

The present invention relates to a stationary device for a mobile device and an electrical connector for the device.

2. Description of the Related Art

Japanese patent application Kohyo No. 10-511213 (JP'213) discloses a connector for bringing terminals of a mating device to regular positions for contact. A first connector has a guide pin, which is fitted in a slot of a second connector. The first and second connectors may be provided on a stationary device and a mobile device, respectively. By placing the mobile device on the stationary device to make an electrical connection between them, power charging and signal exchange are made through the power and signal terminals, respectively.

Japanese patent application Kokai No. 8-17503 (JP'503) discloses a mobile device that is mounted obliquely on the stationary device. As FIG. 9 shows, a mobile device or phone 60 is mounted on a stationary device or battery charger 50 for charging. The battery charger 50 comprises a housing 51 that has an inclined support recess 52 into which the mobile phone 60 is placed. A connector 53 is provided on the bottom of the support recess 52 and has a pin terminal 53A that is movable in an up-and-down direction.

A flat terminal 61 is provided on the bottom of the mobile phone 60 so that when the mobile phone 60 is mounted in the support recess 52, the terminals 53A and 61 are brought into contact with each other for electrical connection. The contact point between the terminals 53A and 61 moves around during the electrical connection, producing the so-called “wiping effect”.

The above connectors 53 and 61, however, have the following disadvantages.

In JP'213, both the devices are connected in a fixed posture so that no wiping effect is obtained.

In JP'503 or FIG. 5, the movement of the contact point is caused by the inclination of the mobile phone 60 and is not extensive. In addition, there is no guide pin, failing to not only keep an accurate position but also meet the needs for a connector having a large number of signal terminals that are arranged densely.

### SUMMARY OF THE INVENTION

Accordingly, it is an object of the invention to provide a stationary device and a connector for the device capable of providing accurate positioning and the wiping effect.

The invention relates a stationary device and an electrical connector for making electrical connection between a mobile device and the stationary device when the mobile device is mounted on said stationary device.

According to an aspect of the invention there is provided an electrical connector which comprises a connector housing having a terminal support; a plurality of terminals having contact sections projecting from said terminal support; a pair of mount guiding columns provided on said connector housing and has such a shape and size as to allow rotation of said mobile device to an inclined position; wherein the contact sections are provided within an outline of the mount guiding columns as viewed in an axial direction of said rotation of said mobile device.

The mobile device is mounted on the stationary device while the mount guiding columns enter the mount recesses (mount beginning position). The mobile device presses downwardly by gravity the contact sections of the stationary connector so that the terminals are flexed to bring the contact sections into contact with each other. Then, the mobile device is rotated to the inclined position (mount complete position) and locked by the receiving member. The contact sections are within the outline of the mount guiding columns so that they do not block the rotation. The rotation causes sliding movement between the terminals under the contact pressure, producing the wiping effect. The sliding distance is obtained by multiplying the rotation radius by the angle between the mount beginning position and the mount complete position so that it is large and so is the wiping effect.

The receiving member may be provided on the mount guiding column or a separate component provided on the connector housing. Where it is provided on the mount guiding column, the height of the mount guiding column should be sufficiently large to stabilize the mobile device at the inclined position.

By providing the receiving member at an end or opposite ends of the terminal support, it is possible to provide a compact connector. If it is spaced apart from the terminal support, the mount guiding column may be made large regardless of the connector. By making circular the tops of the contact sections of the stationary device, it is possible to make smooth sliding between the terminals.

The terminals have a flexible section so that the contact sections are pressed downwardly by the mobile device, the flexible sections are flexed to allow downward movement of the contact sections. The terminals may include power and signal terminals for making not only power charging but also signal exchange. By tilting the mount guiding columns toward the inclined position of the mobile device, it is possible to facilitate mounting the mobile device.

The mount columns may be provided on the connector housing where the connector and the device have separate housings. The mobile electrical connector has mount recesses having bottoms on which the contact sections are provided and a shield plate provided on the inside walls of the mount recesses to cover the contact sections of signal terminals.

### BRIEF DESCRIPTION OF THE DRAWINGS

FIG. 1 is a perspective view of parts of a mobile device and a stationary device according to an embodiment of the invention;

FIG. 2 is a sectional view of the mobile device prior to mount on the stationary device;

FIG. 3 is a sectional view of the mobile device being mounted on the stationary device;

FIG. 4 is a sectional view of the mobile device having been mounted on the stationary device; and

FIG. 5 is a sectional view of conventional mobile and stationary devices.

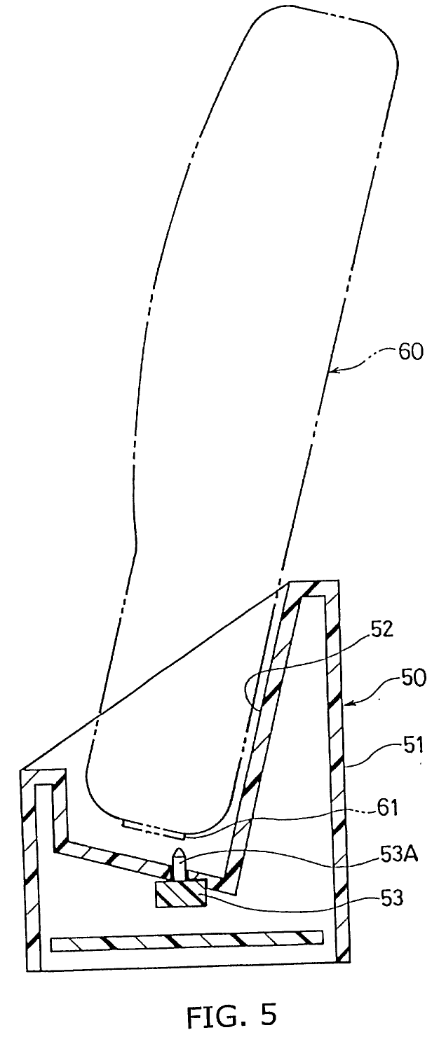

### DESCRIPTION OF THE PREFERRED EMBODIMENT

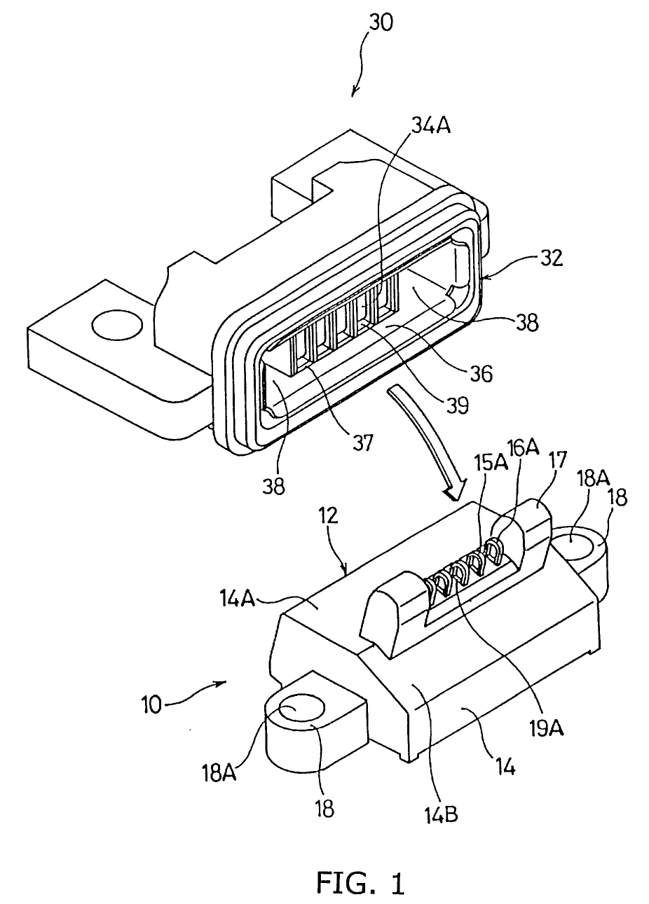

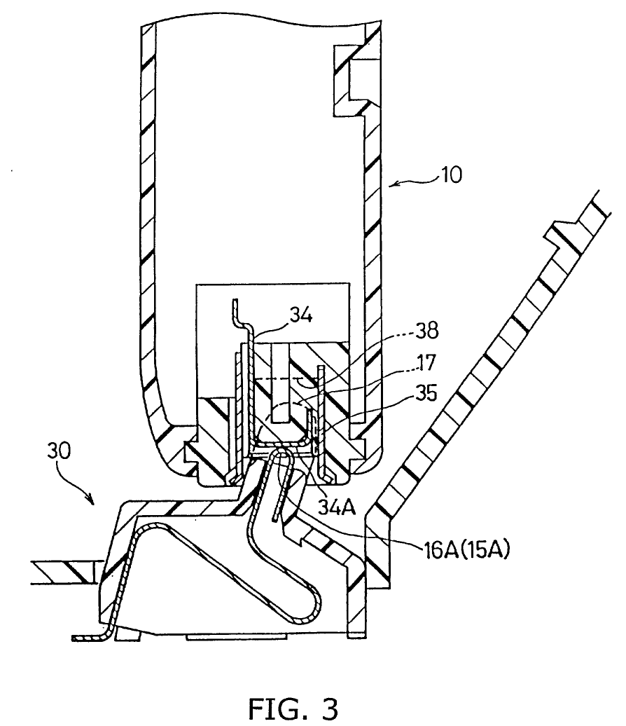

Embodiments of the invention will now be described with reference to the accompanying drawings, FIGS. 1-4.

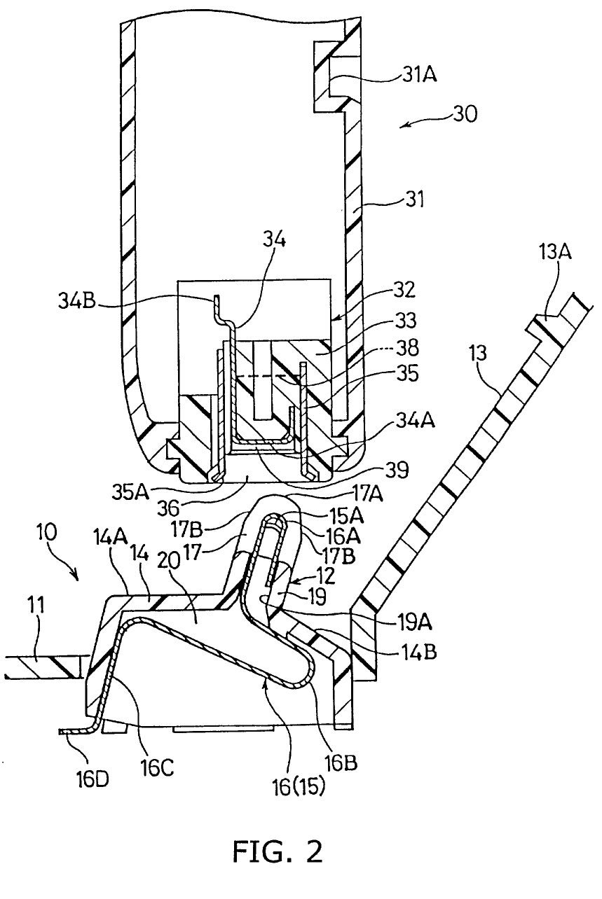

FIG. 1 shows connectors for stationary and mobile devices, respectively. FIG. 2 shows these connectors in section. A stationary device 10 comprises a case 11 that has an upper opening in which a stationary connector 12 provided and a receiving section 13 that extends obliquely from the side of the upper opening and has an engaging projection 13A.

As best shown in FIG. 1, the stationary connector 12 comprises a housing 14 of an insulative material and a plurality of terminals 15 and 16 arranged in the housing 14. The housing 14 has a horizontal face 14A and an inclined face 14B that extends obliquely downwardly from the horizontal face 14A. A pair of mount guiding columns 17 extend obliquely upwardly from the edge between the horizontal and inclined faces 14A and 14B and flank the contact sections 15A and 16A of the terminals 15 and 16. A pair of leg sections 18 extend laterally from opposite sides of the housing 14 and have fixing apertures 18A into which screws are inserted to secure the connector 12 to the stationary device 10.

A terminal support 19 extend upwardly to a half of the height of the mount guiding columns 17 and has a plurality of support slots 19A that support the terminals 15 and 16 and communicate with respective internal spaces 20 of the housing 14. The slots 19A and the internal spaces 20 extend in respective planes parallel to the picture plane of FIG. 2.

The contact section 16A of a power terminal 16 extends upwardly from the terminal support 19 more than the contact section 15A of a signal terminal 15. The power terminals 16 on opposite ends of the terminal row and the signal terminals 15 between them are used to transmit power terminals and signal terminals, respectively. Both the terminals 15 and 16 are identical except for the height of the contact sections 15A and 16A and, therefore, only the power terminal 16 will be described.

In FIG. 2, the power terminal 16 has, from above, a contact section 16A, a flexible section 16B, a fixing section 16C, and a connection section 16D. The contact section 16A has an inverted U-shape that projects from the support slot 19A. The flexible section 16B extends obliquely downwardly from the contact section 16A and then obliquely upwardly to form a U-shaped curve in the internal space 20 so that it is flexed when the contact section 16A is pressed downwardly. The fixing section 16C is brought into close contact with and supported by the inner face of the housing 14. The connection section 16D extends horizontally through the housing 14 and is connected to a corresponding trace of a circuit board provided in the stationary device 10.

The mount guiding column 17 has a circular top face 17A and a pair of inclined side faces 17B. Best shown in FIG. 2, the contact sections 15A and 16A are located within the outline of the guiding columns 17. The mobile device 30, such as mobile telephone, comprises a case 31 and a connector 32 provided on the bottom of the case 31, in which a circuit member (not shown) is accommodated. An engaging recess 31A is provided in a side of the case 31 for engagement with the engaging projection 13A to support the mobile device 30 in an oblique posture.

The connector 32 comprises a housing block 33 of an insulative material, a plurality of terminals 34 provided in the housing block 33, and a shield tube 35 provided around the terminals 34. A receiving cavity 36 is provided in the housing 33 for accommodating the mount guiding columns 17 of the mating connector 12. A terminal island 37 is provided in the receiving cavity 36. A pair of mount recesses 38 are provided in the receiving cavity 36 on opposite sides of the terminal island 37.

A plurality of indentations 39 are provided in the terminal island 37 at positions corresponding to the terminals 15 and 16 of the stationary device 10 for accommodating the contact sections 34A of terminals 34. The contact section 34A is provided at one end of the terminal 34 and has a flat section on the bottom of the indentation 39. The contact sections 34A of a plurality of terminals 34 are at the same level so that the power terminals 16 of the stationary device 10 make contact with the terminals 34 of the mobile device 30 prior to the signal terminals 15. The terminal 34 has at the other end a connection section 34B that is connected to a corresponding circuit (not shown) of the mobile device 30. The shield tube 35 extends along the inside wall of the receiving cavity 36 such that the open edge 35A is located at the open edge of the receiving cavity 36.

The operation of the devices will be described below.

(1) When the mobile device 30 is charged or exchanges signals with the stationary device 10, the mobile device 30 is brought to a position above the stationary device 10 such that the mount recess 38 faces the mount guiding column 17 of the stationary device 10 as shown in FIG. 2.

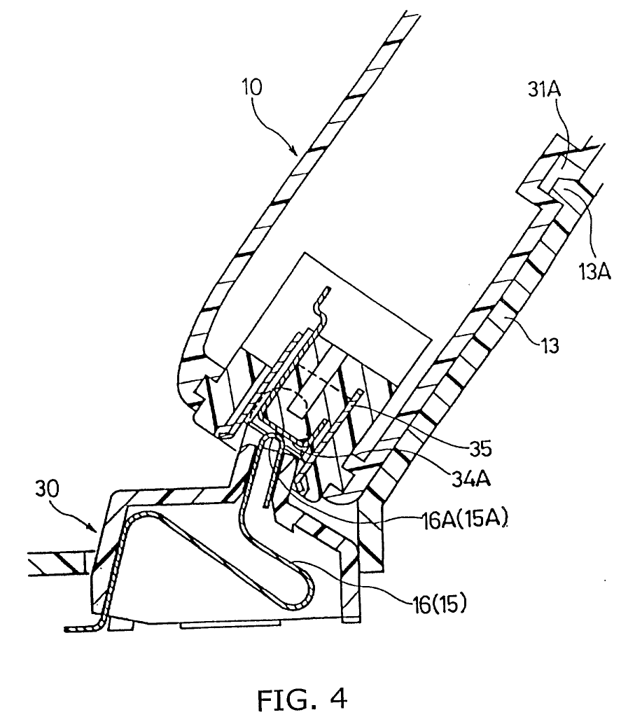

(2) Then, the mobile device 30 is moved downwardly so that the mount guiding column 17 enters the mount recess 38, bringing the respective terminals to predetermined positions as shown in FIG. 4. Since the contact sections 15A and 16A of signal and power terminals 15 and 16 are situated within the outline of the mount guiding column 17 and the contact section 16A of the power terminals 16 extend more than the contact section 15A of the signal terminals 15, first the power terminal 16 and then the signal terminals 15 make contact with the contact sections 34A of mating terminals 34 without contact with the shield case 35 of the mobile device 30.

(3) Then, the mobile device 30 is rotated to the receiving section 13 of the stationary device 10. When the mobile device 30 is rotated to a predetermined position, the engaging recess 31A of the mobile device 30 engages the engaging projection 13A of the receiving section 13 to lock the posture. The contact points between the contact sections 15A and 16A of the stationary device 10 and the contact sections 34A of the mobile device 30 move along with the rotation of the mobile device 30. Since the guiding column 17 is inclined toward the receiving section 13 and has the inclined side faces 17, it is possible to provide a large angle of rotation, producing the strong wiping effect between the contact sections 15A and 16A, and 34A. The terminals 15 and 16 of the stationary device 10 are flexed at the flexible sections by the weight of the mobile device 30 so that the contact sections 15A and 16A are moved resiliently downwardly in the housing 14 and wiped by the contact sections 34 of the mobile device 30 under the resilient force.

(4) Thus, every time the mobile device 30 is mounted on the stationary device 10, the wiping effect of the terminals are obtained to optimize the charging and signal exchange operations through the power and signal terminals, respectively.

A variety of modifications may be made to the illustrated embodiments. For example, the outline of the mount guiding column may be made of a continuously curved line or a plurality of broken lines joined together. At any rate, it is desired that the mounting and rotation of the mobile device on the stationary device be made smooth and the mounting posture be stable. The housing of a connector for each of the devices, especially stationary device, may be integrated with the device case. The receiving section may be integrated with a side wall of the mount guiding column, which is made tall for stabilizing the stationary device. The mount guiding column may stand upright.

As has been described above, according to the invention, the mount guiding column enables not only guide but also rotate the mobile device along the rotation guiding face so that it is possible to not only provide easy and accurate positioning by the mount guiding column but also smooth rotation by the rotation guiding face to provide the wiping effect, resulting in the clean contact sections of terminals.

1. A stationary device for receiving a mobile device therein for electrical connection, said stationary device comprising:
a device case;
an electrical connector supported by said device case, said electrical connector including:
a connector housing having a terminal support;
a plurality of terminals having contact sections projecting from said terminal support;
a pair of mount guiding columns provided on said connector housing and has such a shape and size as to allow rotation of said mobile device to an inclined position; and
a receiving member provided on said connector housing for supporting said mobile device at said inclined position; wherein
said contact sections are provided within an outline of said mount guiding columns as viewed in an axial direction of said rotation of said mobile device.

2. The stationary device according to claim 1, wherein said receiving member is provided on said mount guiding columns.

3. The stationary device according to claim 1, wherein said mount guiding columns are provided on opposite sides of said terminal support.

4. The stationary device according to claim 1, wherein said contact sections have a circular top.

5. The stationary device according to claim 1, wherein said terminals have a flexible section curved within said connector housing so that when said contact sections are pressed downwardly by the mobile device, the flexible sections are flexed to allow downward movement of said contact sections.

6. The stationary device according to claim 1, wherein said terminals include signal and power terminals, respectively.

7. The stationary device according to claim 1, wherein said mount guiding columns are inclined toward said inclined position.

8. A stationary electrical connector for a stationary device that receives a mobile device therein for electrical connection with a mobile electrical connector, said stationary electrical connector comprising:
a connector housing having a terminal support;
a plurality of terminals having a contact section projecting from said terminal support; and
a pair of mount guiding columns provided on opposite sides of said terminal support and having such a shape and size as to allow rotation of said mobile device to an inclined position; wherein
said contact sections are provided within an outline of said mount guiding columns as viewed in an axial direction of said rotation of said mobile device.

9. The mobile electrical connector according to claim 8, which comprises:
a mount recess having a bottom;
a plurality of terminals having contact sections provided on said bottom;
a shield plate provided on an inside wall of said mount recess so as to cover said contact sections of terminals provided in said stationary electrical connector.
